(19) United States
(12) Patent Application Publication
(10) Pub. No.: US 2013/0098981 A1
(43) Pub. Date: Apr. 25, 2013

(54) COUNTER

(71) Applicant: KAN-SHU YEH, New Taipei City (TW)

(72) Inventor: KAN-SHU YEH, New Taipei City (TW)

(21) Appl. No.: 13/277,205

(22) Filed: Oct. 19, 2011

(51) Int. Cl. G06M 1/06

(52) U.S. Cl. 235/103

(57) ABSTRACT

The counter contains a counting member with a rotational shaft extended from the counting member; a base member for positioning the counting member with the rotational shaft extended outside the base member; a cover member with an opening that is jointed to the base member to house the counting member in between and to expose the digits of the counting member by the opening; and a pressing member sleeving over the rotational shaft for engaging the counting member. The counter is structurally simple, convenient to use, not powered by a battery, and of a lower production cost.

### (a) TECHNICAL FIELD OF THE INVENTION

The present invention is generally related to counting devices, and more particular to the counters applied in manufacturing processes.

### (b) DESCRIPTION OF THE PRIOR ART

Counters are widely applied in manufacturing processes for keeping track of the number of items produced or processed. U.S. Pat. No. 5,571,539 teaches a counter or monitor for a casting process. The device is installed on a work station and is powered by a battery.

Conventional counters are complicated structured and costly to produce. And most of them are powered by a battery. If the electricity of the battery is depleted, the counter would fail to work.

### SUMMARY OF THE INVENTION

A major objective of the present invention is to provide a counter that is structurally simple, convenient to use, and not powered by a battery.

To achieve the objective, the counter contains a counting member with a rotational shaft extended from the counting member; a base member for positioning the counting member with the rotational shaft extended outside the base member; a cover member with an opening that is jointed to the base member to house the counting member in between and to expose the digits of the counting member by the opening; and a pressing member sleeving over the rotational shaft for engaging the counting member.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective break-down diagram showing the various components of a counter according to a first embodiment of the present invention.

FIG. 2 is a perspective diagram showing the counter of FIG. 1 from two viewing angles.

FIG. 3 is a perspective diagram showing the internal of the counter of FIG. 1.

FIG. 4 is a schematic diagram showing the interaction between the flipping piece, the flipping teeth, and the stopping piece.

FIGS. 5 to 7 are perspective diagrams showing the advancement of digits on an auxiliary wheel by a driving wheel.

FIG. 8 is a perspective diagram showing a counter according to a second embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

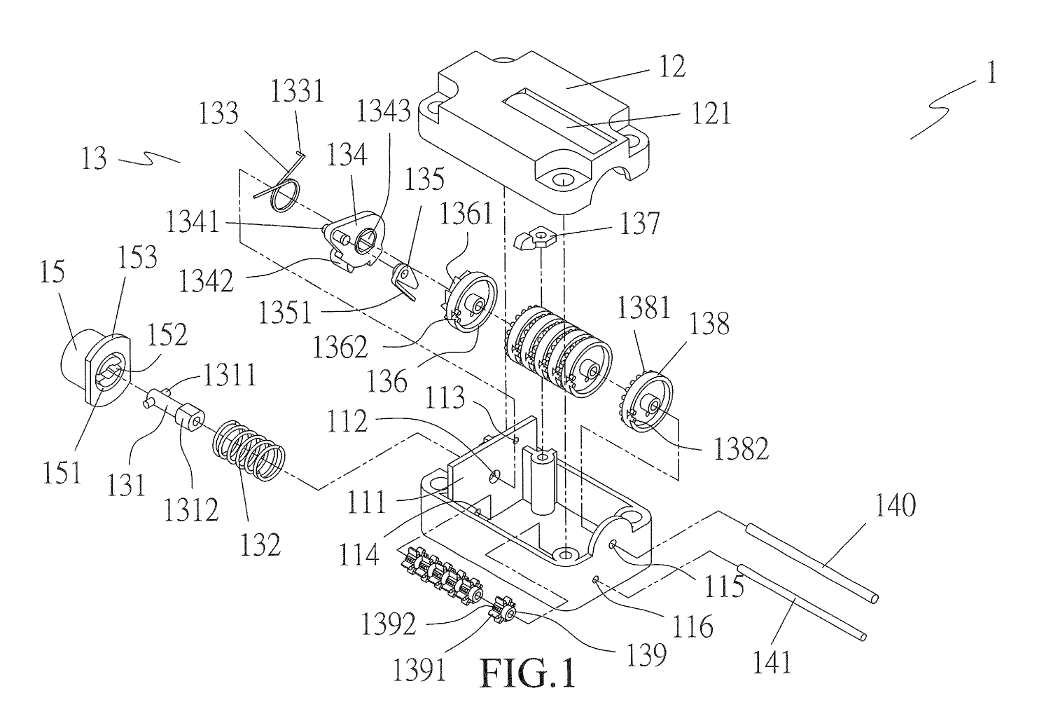

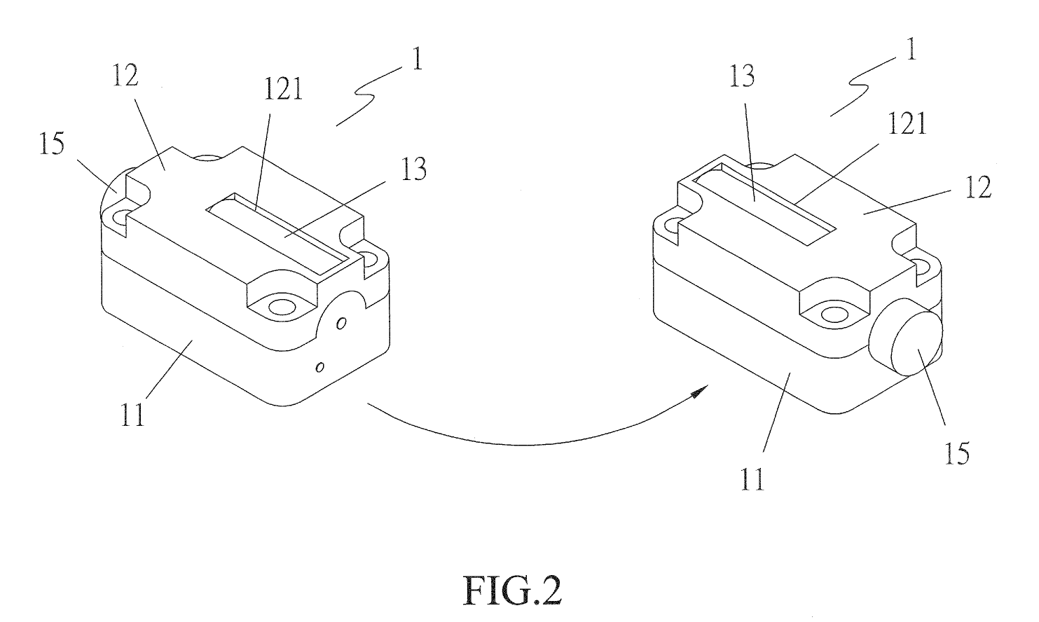

As shown in FIGS. 1 and 2, a counter 1 according to an embodiment of the present invention contains a base member 11, a cover member 12, a counting member 13, and a pressing member 15.

The base member 11 is a rectangular box with an open top side and four channels along four vertical edges for bolts, respectively. For the two shorter lateral sides of the base member 11, one has a curved notch and one has a curve bulge. On the side with the curved bulge, an axial hole 115 is within the curved bulge and another axial hole 116 is beneath the axial hole 115. Adjacent to the side with the curved notch, a wall 111 is configured and a through hole 112, a positioning hole 113, and an axial hole 114 are configured on the wall 111. The through hole 112 and the axial hole 114 are aligned with the axial holes 114 and 116, respectively.

The cover member 12 is also a rectangular box with an open bottom side matching the base member 11 and also four channels along four vertical edges for bolts, respectively. For the two shorter lateral sides of the cover member 12, a curved notch is configured, respectively. On a top side of the cover member 12, an opening 121 is configured.

The counting member 13 contains the following components. There is a rotational shaft 131 with a perpendicular rod 1311 at one end and an engaging element 1312 with an axial hole at the other end.

A resilient element 132 is a helix spring sleeving over the rotational shaft 131.

A restoration element 133 is a metallic wire bended into an l shape with resilience. An end of the restoration element 133 is further bended to form a perpendicular section 1331.

A transmission piece 134 has an embedding hole 1343 matching the engaging element 1312 of the rotational shaft 131, a blocking rod 1341 running perpendicularly through the transmission piece 134, and a pressing element 1342 extended from a circumference of the transmission piece 134.

A flipping piece 135 has a through hole and a flexible element 1351.

A master wheel 136 has a through hole in the center and a number of flipping teeth 1361 on one side around the through hole. On the other side, there are two stopping teeth 1362. Digits 0 to 9 are marked on the circumference of the master wheel 136.

A stopping piece 137 has a flexible stopping element and engages the flipping teeth 1361 of the master wheel 136.

There are a number of auxiliary wheels 138, each having a through hole in the center, a number of biting teeth 1381 on one side, two stopping teeth 1382 running perpendicularly through, and digits 0 to 9 marked on the circumference.

There are a number of driving wheels 139, each having a through hole in the center, a number of long and short teeth 1391 and 1392 alternately configured on the circumference.

A first pin 140 is threaded through the through holes in the center of the auxiliary wheels 138 and the master wheel 136.

A second pin 141 is threaded through the through holes in the center of the driving wheels 139.

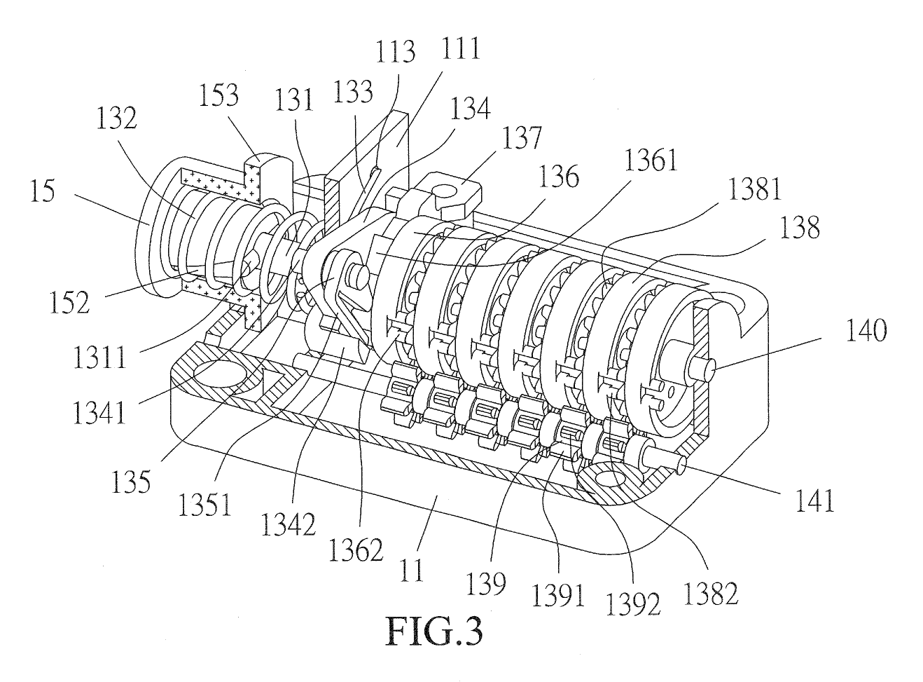

As shown in FIG. 3, the second pin 141 along with the driving wheels 139 are placed inside the base member 11. The two ends of the second pin 141 are embedded into the axial holes 116 and 114. The rotational shaft 131 is threaded through the through hole 112 and extended out of the curved notch of the base member 11. The perpendicular rod 1311 then runs perpendicularly through the rotational shaft 131. The restoration element 133 is sleeved over the engaging element 1312 by its through hole in the center. The perpendicular section 1331 is plugged into the positioning hole 113. The transmission piece 134's embedding hole 1343 receives the engaging element 1312 of the rotational shaft 131. The transmission piece 134 is positioned against the wall 111. A side of the restoration element 133 is against a side of the blocking rod 1341 of the transmission piece 134. The flipping piece 135 is jointed to the other side of the blocking rod 1341. The flexible element 1351 is against an upper edge of the pressing element 1342. The first pin 140 which is threaded through the auxiliary wheels 138 and the master wheel 136 has one end embedded into the axial hole 115 and the other end embedded into the axial hole of the engaging element 1312 of the rotational shaft 131 through the through hole 112 of the wall 111. As such, the driving wheels 139 are adjacent to the master wheel 136 and the auxiliary wheels 138. The long teeth 1391 selectively engage the stopping teeth 1362, 1382, and biting teeth 1381. The short teeth 1392 selectively engage the stopping teeth 1362 and 1382. The counting member 1 is housed between the cover member 12 and the base member 11, and the digits on the master and auxiliary wheels 136 and 138 are exposed out of the opening 121 of the cover member 12.

The resilient element 132 sleeves over the rotational shaft 131. The pressing member 15 has a slant slot 152 inside a storage space 151 on one side with flanges 153 on the side's upper and lower edges. The slant slot 152 receives the perpendicular rod 1311 of the rotational shaft 131, and an end of the resilient element 132 is embedded into the storage space 151. The flanges 153 then fit in the curved notches of the base member 11 and the cover member 12. The resilient element 132 is then confined between the pressing member 15 and the wall 111.

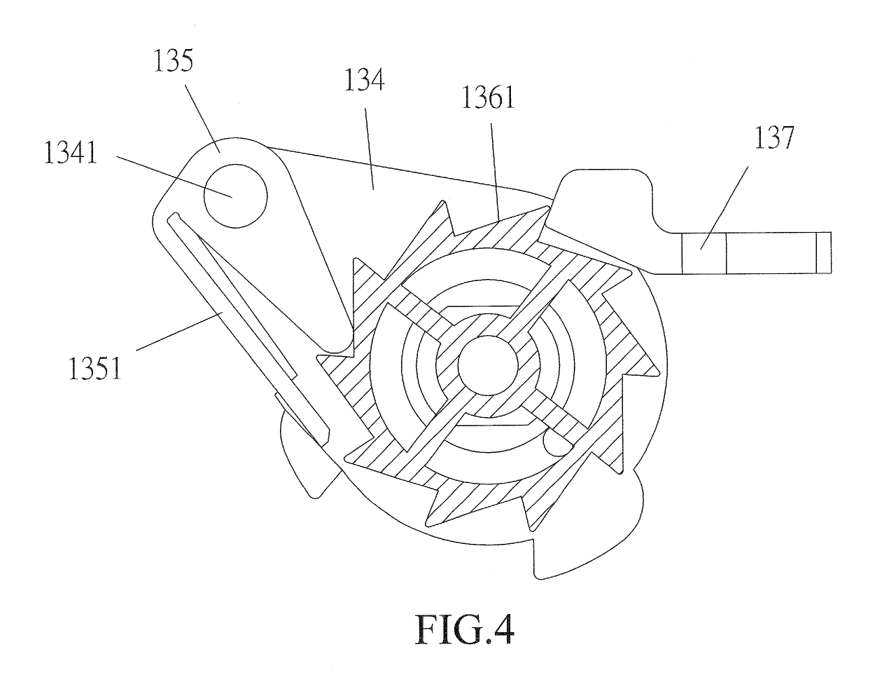

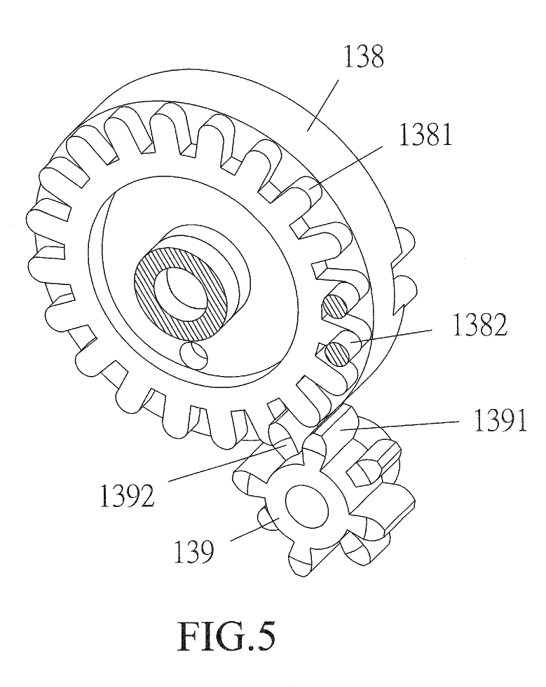

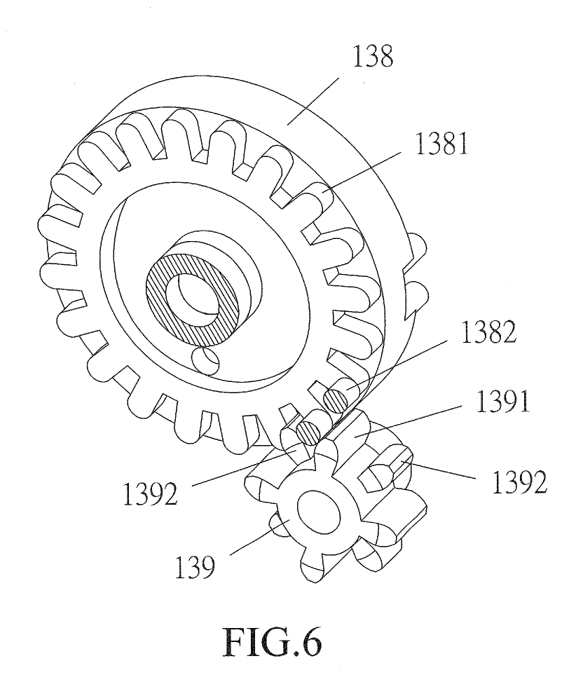

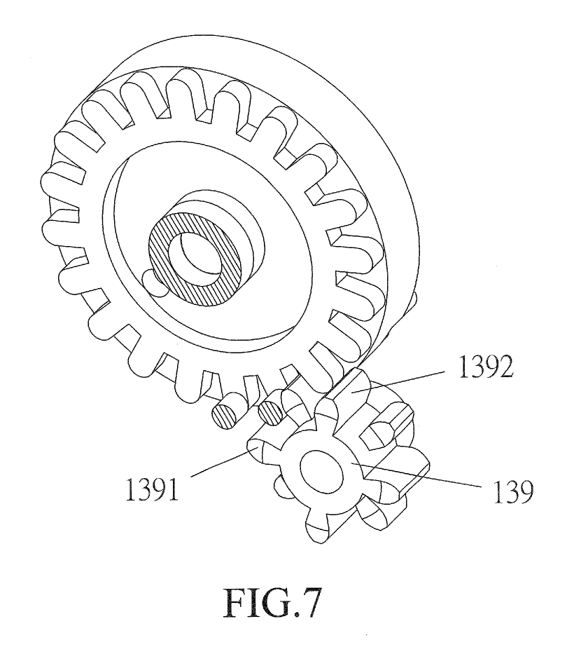

When the pressing member 15 is pressed, the perpendicular rod 1311 and therefore the rotational shaft 131 are engaged by the slant slot 152 to spin. The transmission piece 134 and in turn the flipping piece 135 are engaged. Through the flipping teeth 1361, the master wheel 136 is engaged to spin. Due to the locking between the stopping piece 137 and the flipping teeth 1361 as shown in FIG. 4, the mater wheel 136 does not turn in the opposite direction, and the digits on the master wheel 1361 therefore advances. When the number advances to the next place, the blocking teeth 1362 drive the short teeth 1392 and a driving wheel 139 starts to turn. The long teeth 1391 engage the stopping teeth 1362 and the biting teeth 1381. The master wheel and the auxiliary wheel 136 and 138 as such are engaged simultaneously and the digits on the auxiliary wheel 138 advances. Similarly, when the number advances to the next place, as shown in FIGS. 5 to 7, the blocking teeth 1382 push the short teeth 1392 and a driving wheel 139 starts to turn. The long teeth 1391 engage the stopping teeth 1382 and the biting teeth 1381 of another auxiliary wheel 138. The two auxiliary wheels 138 as such are engaged simultaneously and the digits on the second auxiliary wheel 138 advances. When the pressure on the pressing member 14 is removed, the resilient element 132 pushes the pressing member 15 back to its original position so that the pressing member 15 is ready for the next pressing. The flexibility of the restoration element 133 makes the transmission piece 134 and the flipping piece 135 to return to their initial position. The flexibility of the flexible element 1351 also makes the flipping piece 135 back to its initial position.

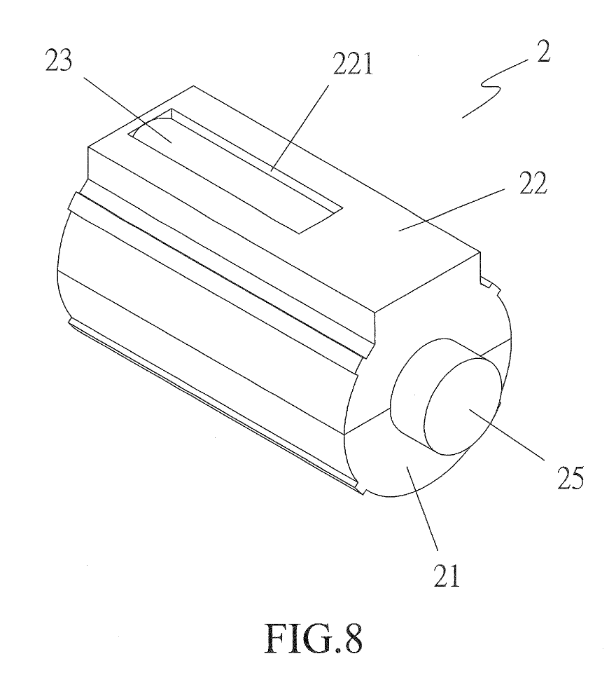

As shown in FIG. 8 which illustrates a second embodiment of the present invention, the base and cover members 21 and 22 are jointed into a cylindrical shape. The cover member 22 also has an opening 221 to reveal the digits of the counting member 23. The counting member 23 is also engaged by a pressing member 25.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A counter, comprising:
a counting member having a rotational shaft extended out of said counting member;
a base member for positioning said counting member with said rotational shaft extended out of said base member;
a cover member with an opening jointed to said base member so that said counting member is housed in between and said counting member's digits exposed out of said opening; and
a pressing member sleeving over said rotational shat for engaging said counting member.

2. The counter according to claim 1, wherein
adjacent to a side of said base member, a wall is configured inside with and a through hole is configured on said wall;
said counting member's said rotational shaft has a perpendicular rod at one end and an engaging element with an axial hole at the other end; said end of said rotational shaft with said perpendicular rod is threaded through said through hole of said wall; said engaging element is positioned inside said base member;
said counting member further comprises:
a resilient element sleeving over said end of said rotational shaft with said perpendicular rod;
a restoration element sleeving over said engaging element of said rotational shaft;
a transmission piece having an embedding hole receiving said engaging element of said rotational shaft, a blocking rod running perpendicularly through said transmission piece, and a pressing element extended from a circumference of said transmission piece;
a flipping piece jointed to a side of said blocking rod and having a flexible element against an upper edge of said pressing element;
a master wheel having a through hole in the center and a plurality of flipping teeth on one side around said through hole and, on the other side, two stopping teeth;
a stopping piece engaging said flipping teeth of said master wheel;
a plurality of auxiliary wheels, each having a through hole in the center, a plurality of biting teeth on one side, and two stopping teeth running perpendicularly through;
a first pin threaded through said through holes in the center of said auxiliary wheels and said master wheel; an end of said first pin embedded into said base member and the other end embedded into said axial hole of said engaging element of said rotational shaft; said flipping piece engaging said flipping teeth of said mater wheel;
a plurality of driving wheels, each having a through hole in the center, a plurality of long and short teeth alternately configured on the circumference;
a second pin threaded through said through holes in the center of said driving wheels; the two ends of said second pin embedded into said base member; said mater wheel being adjacent to said auxiliary wheels;
said long teeth selectively engaging said stopping teeth and biting teeth; and
said short teeth selectively engaging said stopping teeth.

3. The counter according to claim 2, wherein said resilient element is a helix spring; said pressing member sleeves over an end of said rotational shat with said resilient element; said pressing member has a slant slot inside a storage space on one side with flanges on said side's upper and lower edges; said slant slot receives said perpendicular rod of said rotational shaft; and an end of said resilient element is embedded into said storage space.

4. The counter according to claim 2, wherein said restoration element is a metallic wire bended into an t shape with resilience; an end of said restoration element is bended to form a perpendicular section; and said wall has a positioning hole for receiving said perpendicular section.
